(19) United States
(12) Patent Application Publication
(10) Pub. No.: US 2025/0330536 A1
(43) Pub. Date: Oct. 23, 2025

(54) MOBILE PHONE

(71) Applicant: Angang WANG, Guiyang (CN)

(72) Inventor: Angang WANG, Guiyang (CN)

(21) Appl. No.: 19/253,616

(22) Filed: Jun. 27, 2025

Related U.S. Application Data
(63) Continuation of application No. PCT/CN2023/134798, filed on Nov. 28, 2023.

(30) Foreign Application Priority Data
Apr. 20, 2023 (CN) 202310425077.2

(51) Int. Cl. H04M 1/02

(52) U.S. Cl. CPC H04M 1/0279

(57) ABSTRACT

Disclosed is a mobile phone. In the mobile phone, one to four recesses are formed in a back of the mobile phone, the recesses are sized enough to allow one to four fingertips to reach into the recesses, such that the fingertips can cooperate with a palm of the same hand to hold the mobile phone by one hand, while a thumb of the hand can still click or slide a screen freely. Due to a change in a manner of holding the mobile phone by one hand, a screen width of a full-screen mobile phone can be designed to be wider. The wider screen displays the same content, and characters or image elements appear larger, which obviously improves a visual effect and is also conducive to relieving eye fatigue.

### CROSS-REFERENCE TO RELATED APPLICATIONS

This application is a continuation of International Patent Application No. PCT/CN2023/134798 with a filing date of Nov. 28, 2023, designating the United States, now pending, and further claims priority to Chinese Patent Application No. 202310425077.2 with a filing date of Apr. 20, 2023. The content of the aforementioned applications, including any intervening amendments thereto, are incorporated herein by reference.

### TECHNICAL FIELD

The present invention belongs to the field of body of the mobile phone design, in particular to the body design of a wider full-screen mobile phone.

### BACKGROUND OF THE PRESENT INVENTION

At present, a one-handed holding mode of a large-screen full-screen mobile phone on the market is that a thenar eminence of a thumb presses a side frame of the mobile phone, pulps of other fingers press the other side frame of the mobile phone, and the fingertip of the thumb clicks or slides on the screen. Due to the limitation of holding the mobile phone with one hand, a width of the body of the mobile phone is generally limited to 70-80 mm. A wider mobile phone can accommodate a wider screen, but it is not convenient to hold with one hand.

### SUMMARY OF THE PRESENT INVENTION

### Technical Problem

The present invention provides a method for holding a large-screen full-screen mobile phone with one hand and a corresponding body of the mobile phone structure design, which solves a technical problem that it is not convenient to hold with one hand when a width of the body of the mobile phone is greater than 90 mm. Due to a change in a manner of holding the mobile phone with one hand, a screen width of a full-screen mobile phone may be designed to be wider. The wider screen displays the same content, and characters or image elements appear larger, which obviously improves a visual effect and is also conducive to relieving eye fatigue. A business phone with a wider screen is conducive to browsing and editing charts and reports with more content.

### Technical Solution

According the body of the mobile phone structure design of the present invention, a back of the mobile phone is provided with a recess capable of accommodating fingertips to extend into, and a plurality of recesses may be provided. A size of the recess is suitable to accommodate fingertips of one to four fingers except a thumb. The recess has a length of 13-80 mm, a width of 13-25 mm and a depth of 5-15 mm. A plurality of recesses may be combined and arranged on the back of the mobile phone in different styles to meet requirements of holding the mobile phone in various postures. A one-handed holding mode of the large-screen full-screen mobile phone with the recess is that a palm of a hand presses a side frame of the mobile phone, the fingertips of other fingers extend into the recess and pulps thereof press a pit wall of the recess at the same time, and the fingertip of the thumb clicks or slides on the screen. FIG. 1 is a schematic diagram of the present invention in some embodiments. In order to obtain a better effect, the recess needs to be as deep as possible, and an opening of the recess needs to be narrowed appropriately, so that the pit wall of the recess has some strip-shaped protrusions at the opening, and the protrusions are 0.3-6 mm high and 0.3-3 mm wide, as shown in FIG. 2. In order to make better use of the recess, a foldable bracket or handle may be installed in the recess.

### Beneficial Effects

The mobile phone with a width of 80-120 mm designed by the technology may still be held freely with one hand, and even a range of thumb movement on the screen is larger.

### DESCRIPTION OF THE DRAWINGS

FIG. 1a is a schematic diagram showing a back view of a mobile phone according to some embodiments of the present invention.

FIG. 1b is schematic diagram showing a side sectional view of a recess.

FIG. 2 is a schematic diagram of a pit wall of the recess with some strip-shaped protrusions at an opening according to the present invention.

FIG. 3a is a schematic diagram showing the back view of the mobile phone according to some embodiments of the present invention.

FIG. 3b is a schematic diagram showing the side sectional view of the recess.

### DETAILED DESCRIPTION OF PREFERRED EMBODIMENTS

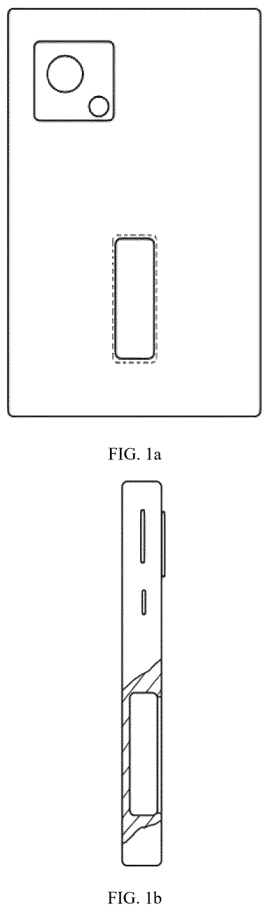

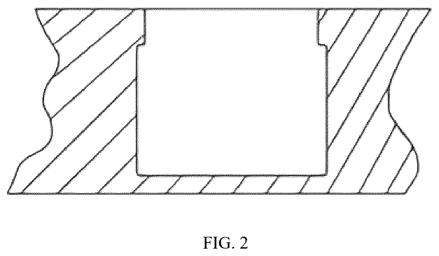

As shown in FIGS. 1a and 1b, a back of a mobile phone is provided with a rectangular recess with four rounded corners, which is vertically arranged at a lower position of the back of the mobile phone and centered left and right, so as to facilitate a left or right hand to hold the mobile phone. The recess has a length of 30-60 mm, a width of 13-25 mm and a depth of 5-15 mm, and a lower edge of the recess is 20-40 mm away from a lower frame of the mobile phone. An opening of the recess is narrowed appropriately, so that a pit wall of the recess has some strip-shaped protrusions at the opening, the protrusions have a height of 0.3-6 mm and a width of 0.3-3 mm, and the protrusions are as shown in FIG. 2.

### DETAILED DESCRIPTION OF EMBODIMENTS

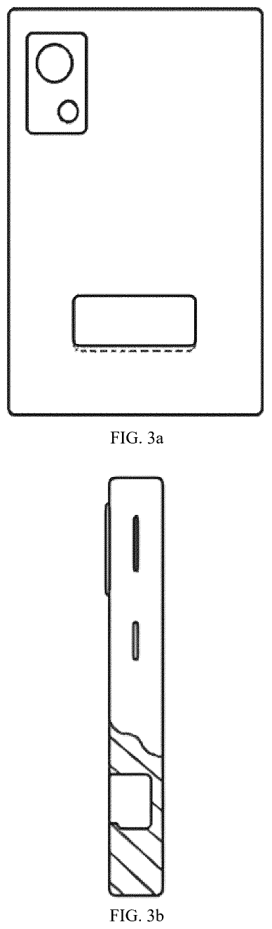

In some embodiments, as shown in FIG. 3a and FIG. 3b, a back of a mobile phone is provided with a rectangular recess with four rounded corners, which is transversely arranged at a lower position of the back of the mobile phone. The recess has a length of 30-60 mm, a width of 13-25 mm and a depth of 5-15 mm, and a lower edge of the recess is 40-60 mm away from a lower frame of the mobile phone. A pit wall of the recess close to a surface of a lower frame of the mobile phone at the opening has some strip-shaped protrusions at the opening, and the protrusions have a height of 0.3-6 mm and a width of 0.3-3 mm.

### INDUSTRIAL PRACTICABILITY

The present invention may be easily realized in the manufacturing of mobile phones.

I claim:

1. A mobile phone, comprising a screen and a body with a shell, wherein a back of the body of the mobile phone is provided with a recess capable of accommodating a fingertip to extend for one hand to hold the mobile phone, and the recess is deep into the body of the mobile phone, so that the mobile phone is held and used with one hand when the fingertip presses a pit wall of the recess and a palm presses a side frame of the mobile phone, and one to four recesses are provided.

2. The recess according to claim 1, wherein the recess has a length of 13-80 mm, a width of 13-25 mm and a depth of 5-15 mm.

3. The recess according to claim 1, wherein a pit wall of the recess is provided with a strip-shaped protrusion along an edge of an opening end, and the protrusion has a height of 0.3-6 mm and a width of 0.3-3 mm.

4. The recess according to claim 1, wherein a foldable bracket or handle is installed in the recess.

5. The recess according to claim 2, wherein the recess is rectangular and has a length of 40-60 m, a width of 13-25 mm and a depth of 5-15 mm, the recess has four rounded corners, and is vertically arranged on the back of the mobile phone and centered left and right, thus being convenient for a left hand or a right hand to hold the mobile phone vertically.

6. The recess according to claim 2, wherein the recess is rectangular and has four round corners, the recess has a length of 40-60 mm, a width of 13-25 mm, and a depth of 5-15 mm, the recess is transversely arranged on the back of the mobile phone, and an upper edge or a lower edge of the recess is 40-60 mm away from a frame of the mobile phone, thus being convenient for the left hand or the right hand to hold the mobile phone transversely.
